(19) United States
(12) Patent Application Publication
(10) Pub. No.: US 2023/0022566 A1
(43) Pub. Date: Jan. 26, 2023

(54) MACHINE LEARNING APPARATUS, ABNORMALITY DETECTION APPARATUS, AND ABNORMALITY DETECTION METHOD

(71) Applicant: KABUSHIKI KAISHA TOSHIBA, Tokyo (JP)

(72) Inventors: Yasutaka FURUSHO, Fuchu Tokyo (JP); Yukinobu SAKATA, Kawasaki Kanagawa (JP); Shuhei NITTA, Tokyo (JP)

(73) Assignee: KABUSHIKI KAISHA TOSHIBA, Tokyo (JP)

(21) Appl. No.: 17/680,984

(22) Filed: Feb. 25, 2022

(30) Foreign Application Priority Data
Jul. 1, 2021 (JP) 2021-110289

(51) Int. Cl. G06N 3/08

(52) U.S. Cl. CPC G06N 3/08

(57) ABSTRACT

According to one embodiment, a machine learning apparatus includes a processing circuit. The processing circuit trains a first learning: parameter of an extraction layer configured to extract feature data of the input data, based on a plurality of training data. The processing circuit trains a second learning parameter of a reconstruction layer configured to generate reconstructed data of the input data, based on a plurality of training feature data obtained by applying the trained extraction layer to the plurality of training data. The second learning parameter represents representative vectors as many as a dimension count of the feature data. The representative vectors as many as the dimension count are based on a weighted sum of the plurality of training data.

### CROSS-REFERENCE TO RELATED APPLICATIONS

This application is based upon and claims the benefit of priority from Japanese Patent Application No. 2021-110289, filed Jul. 1, 2021, the entire contents of which are incorporated herein by reference.

### FIELD

Embodiments described herein relate generally to a machine learning apparatus, an abnormality detection apparatus, and an abnormality detection method.

### BACKGROUND

An abnormality detection apparatus determines whether given diagnostic data is normal or abnormal. The abnormality detection apparatus reconstructs diagnostic data by applying the weighted sum of normal data prepared in advance and determines that the diagnostic data is abnormal if the reconstruction error is larger than a threshold. Since the diagnostic data is reconstructed by the weighted sum of normal data, highly accurate abnormality detection can be implemented using the fact that the reconstruction error of abnormal data is larger than the reconstruction error of normal data. However, to correctly reconstruct normal data, it is necessary to store many normal data in a memory and perform reconstruction using these. For this reason, an enormous memory capacity depending on the number of normal data is required for reconstruction.

### BRIEF DESCRIPTION OF THE DRAWINGS

FIG. 1 is a view showing an example of the network configuration of a machine learning model according to the embodiment;

FIG. 2 is a block diagram showing an example of the configuration of a machine learning apparatus according to the first embodiment;

FIG. 3 is a flowchart showing an example of the procedure of training processing of a machine learning model;

FIG. 4 is a view schematically showing the learning parameter of a reconstruction layer;

FIG. 5 is a view showing an example of image expression of representative vectors;

FIG. 6 is a view showing an example of display of a graph representing a false detection rate for each threshold;

FIG. 7 is a block diagram showing an example of the configuration of an abnormality detection apparatus according to the second embodiment;

FIG. 8 is a flowchart showing an example of the procedure of abnormality detection processing;

FIG. 9 is a view schematically showing equation expression of an operation in the reconstruction layer;

FIG. 10 is a view schematically showing image expression of an operation in the reconstruction layer; and

FIG. 11 is a graph showing the abnormality detection performance of a machine learning model.

### DETAILED DESCRIPTION

A machine learning apparatus according to the embodiment includes a processing circuit. The processing circuit trains a first learning parameter of an extraction layer configured to extract, from input data, feature data of the input data, based on a plurality of training data. The processing circuit trains a second learning parameter of a reconstruction layer configured to generate reconstructed data of the input data, based on a plurality of training feature data obtained by applying the trained extraction layer to the plurality of training data. The second learning parameter represents representative vectors as many as a dimension count of the feature data, and the representative vectors as many as the dimension count are defined by a weighted sum of the plurality of training data.

A machine learning apparatus, an abnormality detection apparatus, and an abnormality detection method according to the embodiment will now be described with reference to the accompanying drawings.

The machine learning apparatus according to this embodiment is a computer that trains a machine learning model configured to determine the presence/absence of abnormality of input data. The abnormality detection apparatus according to this embodiment is a computer that determines the presence/absence of abnormality of input data concerning an abnormality detection target using the machine learning model trained by the machine learning apparatus.

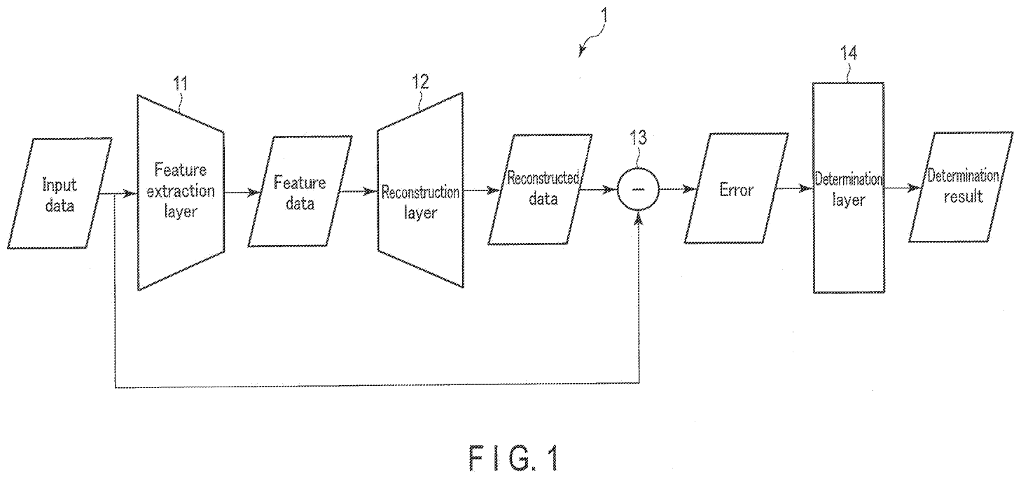

FIG. 1 is a view showing an example of the network configuration of a machine learning model 1 according to this embodiment. As shown in FIG. 1, the machine learning model 1 is a neural network trained to receive input data and output a result of determining the presence/absence of abnormality of the input data. As an example, the machine learning model 1 includes a feature extraction layer 11, a reconstruction layer 12, an error calculation layer 13, and a determination layer 14. Each of the feature extraction layer 11, the reconstruction layer 12, the error calculation layer 13, and the determination layer 14 is formed by a fully connected layer, a convolutional layer, a pooling layer, a softmax layer, or another arbitrary network layer.

Input data in this embodiment is data input to the machine learning model 1, and is data concerning an abnormality determination target. As the type of the input data according to this embodiment, image data, network security data, voice data, sensor data, video data, or the like can be applied. The input data according to this embodiment varies depending on the abnormality determination target. For example, if the abnormality determination target is an industrial product, the image data of the industrial product, output data from a manufacturing machine for the industrial product, or output data from the inspection device of the manufacturing machine is used as the input data. As another example, if the abnormality determination target is a human body, medical image data obtained by a medical image diagnostic apparatus, clinical examination data obtained by a clinical examination device, or the like is used as the input data.

The feature extraction layer 11 is a network layer that receives the input data and outputs the feature data of the input data. The reconstruction layer 12 is a network layer that receives the feature data and outputs reconstructed data that reproduces the input data. The error calculation layer 13 is a network layer that calculates the error between the input data and the reconstructed data. The determination layer 14 is a network layer that outputs the determination result of the presence/absence of abnormality of the input data based on comparison between a threshold and the error output from the error calculation layer 13. As an example, an abnormal or normal class is output as the determination result.

The feature extraction layer 11 and the reconstruction layer 12 train the learning parameters such that normal data is reproduced, and determination result is not reproduced by the combination of the feature extraction layer 11 and the reconstruction layer 12. Here, normal data means input data when the abnormality determination target is normal, and abnormal data means input data when the abnormality determination target is abnormal. Typically, abnormal data cannot be obtained at the time of training of the machine learning model 1, and the machine learning model 1 is trained using normal data. For this reason, the feature extraction layer 11 and the reconstruction layer 12 can reproduce normal data and inhibit reproduction of abnormal data. If the input data is normal data, the error between the input data and the reconstructed data has a relatively small value. If the input data is abnormal data, the error between the input data and the reconstructed data has a relatively large value. Hence, when an appropriate threshold is set, if the input data is normal data, it is correctly determined as “normal”, and if the input data is abnormal data, it is correctly determined as “abnormal” (First Embodiment.

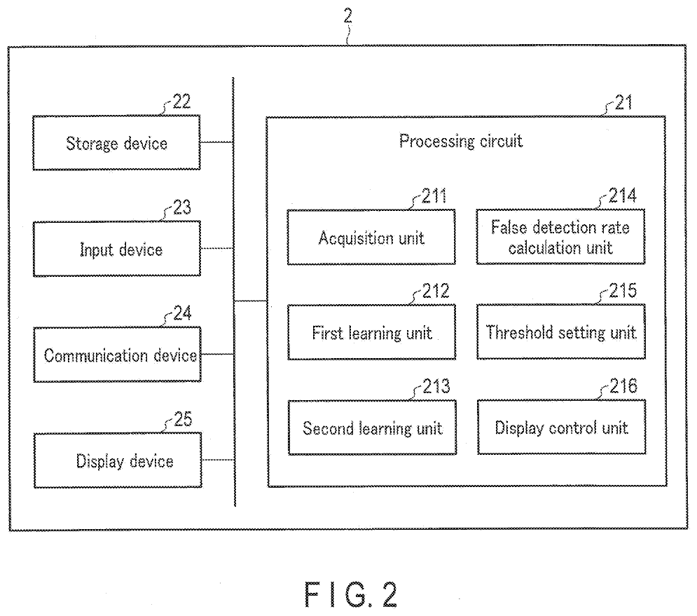

FIG. 2 is a block diagram showing an example of the configuration of a machine learning apparatus 2 according to the first embodiment. As shown in FIG. 2, the machine learning apparatus 2 is a computer including a processing circuit 21, a storage device 22, an input device 23, a communication device 24, and a display device 25. Data communication between the processing circuit 21, the storage device 22, the input device 23, the communication device 24, and the display device 25 is performed via a bus.

The processing circuit 21 includes a processor such as a CPU (Central Processing Unit), and a memory such as a RAM (Random Access Memory). The processing circuit 21 includes an acquisition unit 211, a first learning unit 212, a second learning unit 213, a false detection rate calculation unit 214, a threshold setting unit 215, and a display control unit 216. The processing circuit 21 executes a machine learning program concerning machine learning according to this embodiment, thereby implementing the functions of the units 211 to 216. The machine learning program is stored in a non-transitory computer-readable storage medium such as the storage device 22. The machine learning program may be implemented as a single program that describes all the functions of the units 211 to 216, or may be implemented as a plurality of modules divided into several functional units. In addition, the units 211 to 216 may be implemented by an integrated circuit such as an ASIC (Application Specific Integrated Circuit). In this case, the units may be implemented on a single integrated circuit, or may be individually implemented on a plurality of integrated circuits.

The acquisition unit 211 acquires a plurality of training data. The training data means input data for training. The training data may be normal data, or may be abnormal data.

The first learning unit 212 trains the first learning parameter of the feature extraction layer 11 based on the plurality of training data. Here, the first learning parameter means the learning parameter of the feature extraction layer 11. The learning parameter is a parameter as the training target of machine learning, and is, for example, a weight parameter or a bias.

The second learning unit 213 trains the second learning parameter of the reconstruction layer 12 based on a plurality of training feature data obtained by applying the trained feature extraction layer 11 to the plurality of training data. Here, the second learning parameter means the learning parameter of the reconstruction layer 12. As an example, the second learning parameter represents representative vectors as many as the dimensions of feature data. The representative vectors as many as the dimensions are defined by the weighted sum of the plurality of training data. The second learning unit 213 trains the second learning parameter by minimizing the error between the training feature data and training reconstructed data obtained by applying the training feature data to the reconstruction layer 12.

The false detection rate calculation unit 214 calculates a false detection rate concerning abnormality detection based on the training feature data obtained by applying the trained feature extraction layer 11 to the training data and the training reconstructed data obtained by applying the trained reconstruction layer 12 to the training feature data. More specifically, the false detection rate calculation unit 214 calculates the probability distribution of the error between the training feature data and the training reconstructed data, and calculates a probability for making the error equal to or more than a threshold in the probability distribution as the false detection rate.

The threshold setting unit 215 sets a threshold (to be referred to as an abnormality detection threshold hereinafter) for abnormality detection, which is used by the determination layer 14. The threshold setting unit 215 sets the abnormality detection threshold to a value designated on a graph representing the false detection rate for each threshold.

The display control unit 216 displays various kinds of information on the display device 25. As an example, the display control unit 216 displays the false detection rate in a predetermined display form. More specifically, the display control unit 216 displays a graph representing the false detection rate for each threshold.

The storage device 22 is formed by a ROM (Read Only Memory), an HDD (Hard Disk Drive), an SSD (Solid State Drive), an integrated circuit storage device, or the like.

The storage device 22 stores training data, a machine learning program, and the like.

The input device 23 inputs various kinds of instructions from a user. As the input device 23, a keyboard, a mouse, various kinds of switches, a touch pad, a ouch panel display, and the like can be used. An output signal from the input device 23 is supplied to the processing circuit 21. Note that the input device 23 may be an input device of a computer connected to the processing circuit 21 by a cable or wirelessly.

The communication device 24 is an interface configured to perform data communication with an external device connected to the machine learning apparatus 2 via a network. For example, the communication device 24 receives training data from a training data generation device, a storage device, or the like.

The display device 25 displays various kinds of information. As an example, the display device 25 displays a false detection rate under the control of the display control unit 216. As the display device 25, a CRT (Cathode-Ray Tube) display, a liquid crystal display, an organic EL (Electro Luminescence) display, an LED (Light-Emitting Diode) display, a plasma display, or another arbitrary display known in the technical field can appropriately be used. Also, the display device 25 may be a projector.

Training processing of the machine learning model 1 by the machine learning apparatus 2 according to the first embodiment will be described below. In this embodiment, as an example, input data is image data in which one number of “0” to “9” is drawn. Image data in which “0” is drawn is abnormal data, and image data in which one of remaining “1” to “9” is drawn is normal data. In this embodiment, training data is normal data.

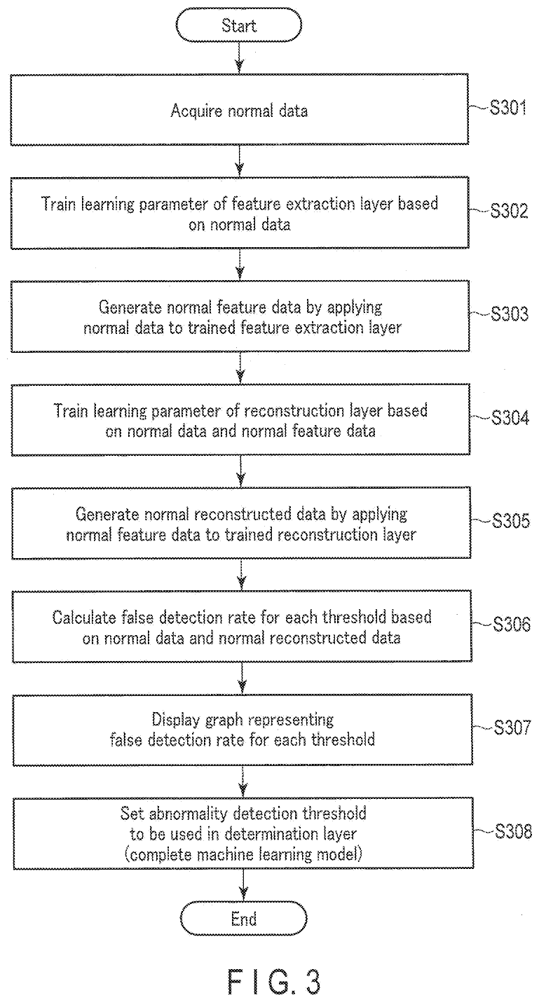

FIG. 3 is a flowchart showing an example of the procedure of training processing of the machine learning model 1. The training processing shown in FIG. 3 is implemented by the processing circuit 21 reading out a machine learning program from the storage device 22 or the like and executing processing in accordance with the description of the machine learning program.

As shown in FIG. 3, the acquisition unit 211 acquires normal data (step S301). In step S301, N normal data are acquired. Here, normal data is expressed as xi (i=1, 2, . . . , N). A suffix i is the serial number of normal data, and N is the number of prepared data. In normal data xi, 28×28 images are arranged to form 784-dimensional real number vector.

When step S301 is performed, the first learning unit 212 trains a learning parameter Θ of the feature extraction layer 11 based on the normal data xi acquired in step S301 (step S302). In step S302, the first learning unit 212 trains the learning parameter Θ of the feature extraction layer 11 by contrastive learning based on the N normal data xi. Step S302 will be described below in detail.

The feature extraction layer 11 is a function for receiving data x as an input and outputting a feature ϕ(x). The learning parameter Θ is assigned to the feature extraction layer 11. The data x is a 784-dimensional real number vector, and a feature Φ(x) is an H-dimensional real number vector. H is preferably set to an arbitrary natural number as long as it is smaller than the dimension count of the data x.

In step S302, the first learning unit 212 generates extended normal data x'i from the normal data xi. As an example, the normal data xi including 28×28 images is rotated or enlarged/reduced at random, thereby performing data extension processing and arranging the normal data after the data extension processing to a 784-dimensional vector. Accordingly, the extended normal data x'i is generated. The extended normal data x'i is also an example of the normal data xi.

Next, the first learning unit 212 initializes the learning parameter Θ of the untrained feature extraction layer 11. The initial value of the learning parameter Θ is preferably set at random. Note that the initial value of the learning parameter Θ may be set to a predetermined value.

Next, the first learning unit 212 inputs the normal data xi to the feature extraction layer 11 and outputs feature data z₂ᵢ₋₁=Φ(xi), and inputs the extended normal data x'i to the feature extraction layer 11 and outputs feature data z₂ᵢ1=Φ(x'i).

The first learning unit 212 trains the learning parameter Θ such that a contrastive loss function L shown in equation (1) is minimized. As an optimization method, stochastic gradient descent or the like is preferably used. The contrastive loss function L is defined by the total sum of a normalized temperature-scaled cross entropy l(2i-l, 2i) of the feature data z₂ᵢ₋ₗ for the feature data z₂ᵢ₋ₗ and a normalized temperature-scaled cross entropy l(2i, 2i-l) of the feature data z₂ᵢ for the feature data z₂ᵢ. B is the suffix set of data used in a mini batch of stochastic gradient descent, ═B═ is the number of elements of the set B, s_{i,j} is the cosine similarity between a vector zᵢ and a vector zⱼ, and τ is a temperature parameter set by the user. In equation (1), 1 is a characteristic function that takes 1 when k≠ i.

$$L = \frac{1}{2 \vert B \vert} {\sum }_{i ∈ B} [ ℓ ( 2 i - 1 , 2 i ) + ℓ ( 2 i , 2 i - 1 ) ] \qquad ( 1 )$$

where

[symbol]

$$ℓ ( i , j ) = - log \frac{exp ( {s}_{i , j} / τ )}{{\sum }_{k ∈ B} {1}_{( k != i )} exp ( {s}_{i , k} / τ )}$$

Contrastive learning for the feature extraction layer 11 is performed by minimizing the contrastive loss function L shown in equation (1). In the contrastive learning shown in equation (1), training is performed such that the cosine similarity between the feature data z₂ᵢ₋ₗ, based on given normal data xi and the feature data z₂ᵢ based on the extended normal data x'i becomes large, and training is performed such that the cosine similarity between the feature data z₂ᵢ₋ₗ based on the normal data xi and the feature data zⱼ (where j≠2i, 2i-1) of data in a mini batch that is not associated with that becomes small. That is, the combination of the feature data z₂ᵢ₋ₗ based on given normal data xi and the feature data z₂ᵢ based on the extended normal data x'i is used as a positive example, and the combination of the feature data z₂ᵢ based on the normal data xi and the feature data zⱼ of data in the mini batch that is not associated with that is used as a negative example. Note that the feature data zⱼ includes the feature data z₂ᵢ₋ₗi based on another normal data that is not associated with the normal data xi and the feature data z₂ᵢ based on the extended normal data x'i that is not associated with the normal data xi.

When step S302 is performed, the second learning unit 213 applies the trained feature extraction layer 11 generated in step S302 to the normal data xi acquired in step S301, thereby generating normal feature data Φ(xi) (step S303).

When step S303 is performed, the second learning unit 213 trains a learning parameter W of the reconstruction layer 12 based on the normal data xi acquired in step S301 and the normal feature data Φ(xi) generated in step S303 (step S304). The reconstruction layer 12 is a linear regression model.

In step S304 first, the second learning unit 213 applies the normal feature data Q (xi) to the untrained reconstruction layer 12; thereby generating normal reconstructed data yi=WΦ(xi). Next, the second Learning unit 213 optimizes the learning parameter W to minimize the error between the normal data xi and the normal reconstructed data yi.

More specifically, the learning parameter W is optimized to minimize the loss function L shown in equation (2). The loss function L is defined by the sum of the total sum of square errors between the normal data xi and the normal reconstructed data yi and the regularization term of the learning parameter W. λ is a regularization intensity parameter set by the user. Since the learning parameter W is decided by minimizing the loss function L to which the regularization term of the learning parameter W is added, the reconstruction by the reconstruction layer 12 can be called kernel ridge reconstruction.

$$L = {\sum }_{i = 1}^{N} {‖ xi - yi ‖}^{2} + λ {‖ W ‖}^{2} \qquad ( 2 )$$

The learning parameter W that minimizes equation (2) can be analytically expressed, as shown by equation (3). X is a value obtained by arranging the normal data xi (i=1, 2, . . . , N) in each column of a real valued matrix of 784×N, and Φ(X) is a value obtained by arranging the feature F (xi) of the normal data in each column of a real valued matrix of H×N.

W=XΦ(X)^{τ}[Φ(X)Φ(X)^{τ}+λI]⁻¹ (3)

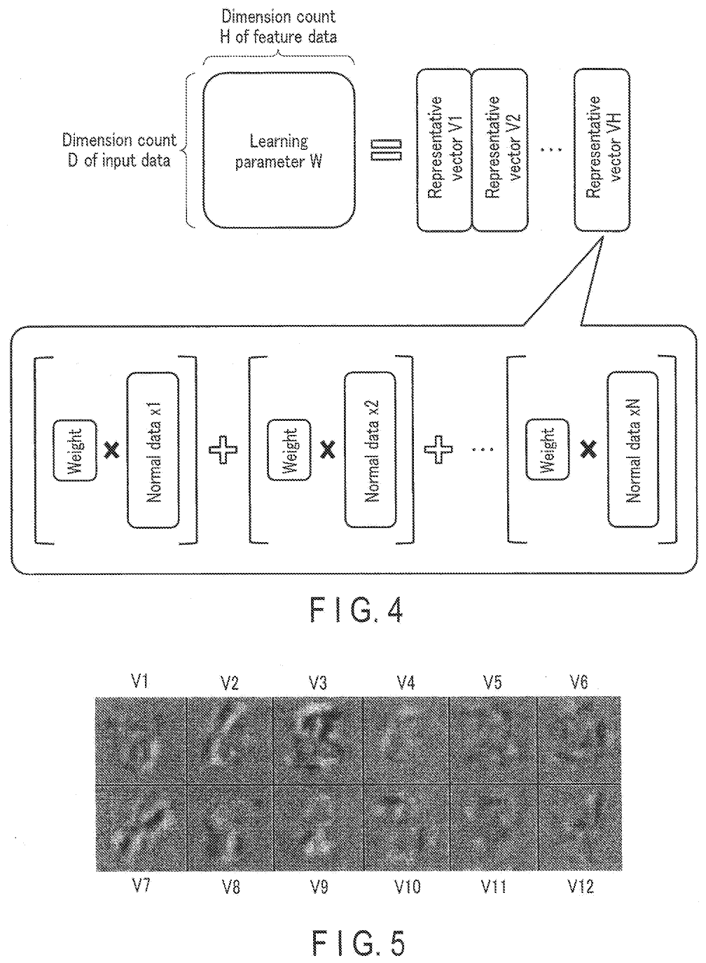

FIG. 4 is a view schematically showing the learning parameter w of the reconstruction layer 12. As shown in FIG. 4, the number of horizontal rows of the learning parameter W equals a dimension count D of input data (or normal data), and the number of vertical columns equals a dimension count H of feature data. The dimension count is smaller than the number N of normal data xi. As is apparent from equation (3), it can be considered that the learning parameter W is formed by arranging H representative vectors Vh (n is a suffix representing a representative vector) in the vertical columns. Each representative vector Vh corresponds to the weighted sum of N normal data xi prepared in advance. Each weight has a value based on N normal feature data. More specifically, each weight corresponds to a component corresponding to each normal data xi in Φ(X)^{T}[Φ(X)Φ(X)^{T}+λI]⁻¹ shown by equation (3).

FIG. 5 is a view showing an example of image expression of the representative vectors Vh. FIG. 5 shows 12 representative vectors V1 to V12. That is, the dimension count H=12 in FIG. 5. As shown in FIG. 5, each representative vector Vh is image data having the same image size of 24×24 as the normal data xi. As is apparent, each representative vector Vh is the weighted sum of number images from “1” to “9” and has a feature such as the strokes of the numbers from “1” to “9”.

Details of training of the feature extraction layer 11 and the reconstruction layer 12 will be described here. The square error between input data x and reconstructed data y can be expressed by

∥x−y∥²=∥x∥²+∥y∥²−2x^{T}Xϕ(X)^{T}{ϕ(X)ϕ(X)^{T}+λI}⁻¹ϕ(x) (4)

According to equation (4), to achieve a high w abnormality detection accuracy, it is preferable to have the following two characteristics. 1. If the input data x is normal data, the error between the input data x and the reconstructed data y is small. 2. If the input data x is abnormal data, the error between the input data x and the reconstructed data y is large.

Placing focus on the third term on the right-hand side of equation (4), the above-described two characteristics can be reworded as follows. 1. When the input data x is normal data, if the inner product of the input data is large (or small), the inner product of the feature data is also large (or small). That is, the inner product of the input data and the inner product of the feature data have positive correlation. Note that the inner product of the input data is x^{T}X in equation (4), and the inner product of the feature data is ϕ(X)^{T}{ϕ(X)ϕ(X)^{T}+λI}⁻¹ϕ(x) in equation (4) Its metric space is the inverse matrix of covariance. 2. When the input data x is abnormal data, if the inner product of the input data is large (or small), the inner product of the feature data is small (or large). That is, the inner product of the input data and the inner product of the feature data have negative correlation.

In this embodiment, the learning parameter Θ is trained such that the feature extraction layer 11 has the characteristic 1. That is, If training data includes only normal data (strictly, normal data and extended normal data), the first learning unit 212 trains the learning parameter of the feature extraction layer 11 such that the positive correlation between the inner product of two normal data and the inner product of two feature data corresponding to the two normal data becomes high. This is because abnormal data cannot be prepared at the time of training in a normal case. As another reason, the inner product of normal data and extended normal data thereof is large, and in contrastive learning, training is performed such that the inner product of the pair of feature data based on normal data and feature data based on the extended normal data of the normal data becomes large, and training is performed such that the inner product of the pair of feature data based on normal data and feature data of data in a mini batch that is not associated with that becomes small.

When step S304 is performed, the false detection rate calculation unit 214 applies the trained reconstruction layer 12 generated in step S304 to the normal feature data Φ(xi) generated in step S303, thereby generating the normal reconstructed data yi (step S305).

When step S305 is performed, the false detection rate calculation unit 214 calculates a false detection rate for each threshold based on the normal data xi acquired in step S301 and the normal reconstructed data yi generated in step S305 (step S306). The false detection rate means a rate of determining normal data as abnormal data.

In step S306, first, the false detection rate calculation unit 214 calculates a probability distribution p of the error between the normal data xi and the normal reconstructed data yi. The error may be an index such as a square error, an L1 loss, or an L2 loss as long as it is an index capable of evaluating the difference between the normal data xi and the normal reconstructed data yi. In the following description, the error is a square error. Next, for each of a plurality of thresholds r, the false detection rate calculation unit 214 calculates a probability (∥xi−yi∥>r) that the square error becomes equal to or larger than the threshold r in the probability distribution p. The threshold r is preferably set to an arbitrary value within a possible range. The calculated probability is used as a false detection rate.

When step S306 is performed, the display control unit 216 displays a graph representing the false detection rate for each threshold (step S307). The graph representing the false detection rate for each threshold is displayed on the display device 25 or the like.

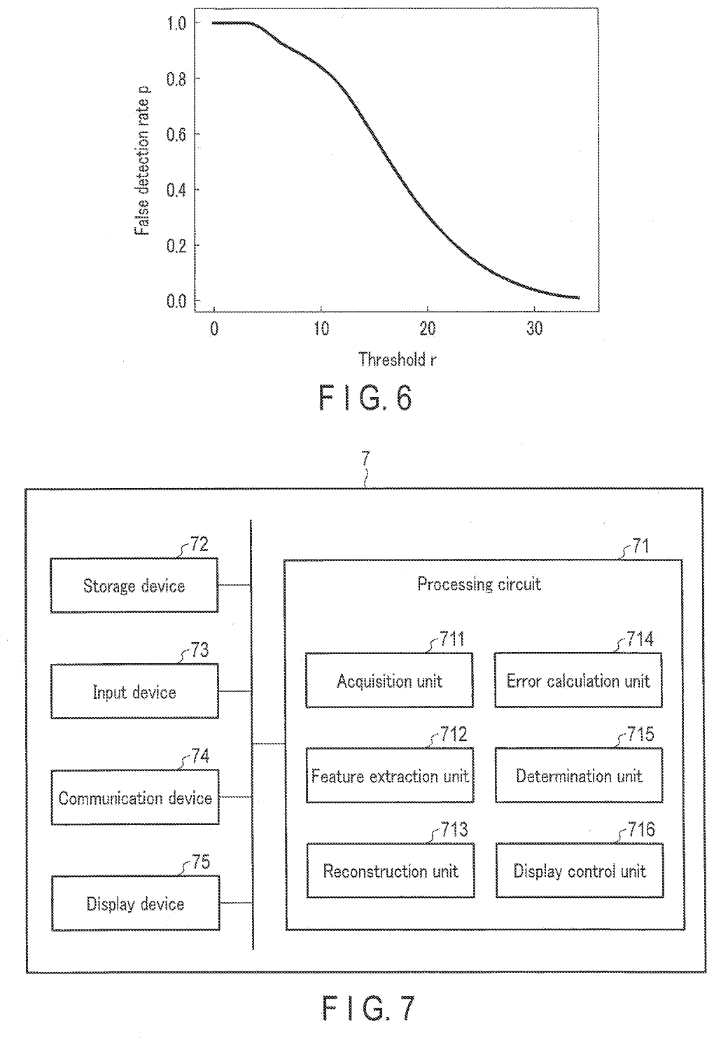

FIG. 6 is a view showing an example of display of the graph representing the false detection rate for each threshold. As shown in FIG. 6, the ordinate of the graph represents the false detection rate, and the abscissa represents the threshold. In FIG. 6, as for the relationship between the threshold r and the false detection rate p, the higher the threshold r is, the lower the false detection rate p is.

When step S307 is performed, the threshold setting unit 215 sets an abnormality detection threshold to be used by the determination layer 14 (step S308). For example, the operator observes the graph shown in FIG. 6 and decides the appropriate threshold r. The operator designates the decided threshold r via the input device 23. As the designation method, for example, the threshold r is designated by a cursor or the like on the graph shown in FIG. 6. Alternatively, the numerical value of the threshold r may be input via a keyboard or the like. The threshold setting unit 215 sets the designated threshold r to the abnormality detection threshold to be used by the determination layer 14.

When steps S301 to S308 are performed, the learning parameter of the feature extraction layer 11, the learning parameter of the reconstruction layer 12, and the abnormality detection threshold of the determination layer 14 are decided. The learning parameter of the feature extraction layer 11, the learning parameter of the reconstruction layer 12, and the abnormality detection threshold of the determination layer 14 are set in the machine learning model 1. The trained machine learning model 1 is thus completed. The trained machine learning model 1 is stored in the storage device 22. In addition, the trained machine learning model 1 is transmitted to an abnormality detection apparatus according to the second embodiment via the communication device 24.

Training processing of the machine learning model 1 is thus ended.

Note that the above-described embodiment is merely an example. The embodiment is not limited to this, and various changes and modifications can be made. For example, in step S306, the false detection rate calculation unit 214 calculates the false detection rate using correct answer data used to train the feature extraction layer 11 and the reconstruction layer 12. However, the false detection rate calculation unit 214 may calculate the false detection rate using another correct answer data that is not used to train the feature extraction layer 11 and the reconstruction layer 12.

The advantage of the weight parameter W according to this embodiment will be described here using a neural network nearest neighbor method shown in non-patent literature (Y. Kato et al, “An Anomaly Detection Method with Neural Network Near Neighbor”, The Annual Conference of the Japanese Society for Artificial Intelligence, 2020) as a comparative example. In the neural network nearest neighbor method, reconstructed data is generated using a DTM (Data Transformation Matrix). The data size of the DTM depends on the number of training data and the dimension count of input data. The number of training data is enormous. Hence, in the neural network nearest neighbor method, a large memory capacity is required to generate reconstructed data.

The data size of the weight parameter W according to this embodiment depends on the dimension count H of feature data and the dimension count of input data. The dimension count H of feature data is smaller than the number N of normal data to be used for training, Hence, the data size of the weight parameter W according to this embodiment is smaller than the data size of the DTM shown in the comparative example. Hence, according to this embodiment, the memory capacity necessary for generation of reconstructed data can be reduced as compared to the comparative example.

### Second Embodiment

FIG. 7 is a block diagram showing an example of the configuration of an abnormality detection apparatus 7 according to the second embodiment. As shown in FIG. 7, the abnormality detection apparatus 7 is a computer including a processing circuit 71, a storage device 72, an input device 73, a communication device 74, and a display device 75, Data communication between the processing circuit 71, the storage device 72, the input device 73, the communication device 74, and the display device 75 is performed via a bus.

The processing circuit 71 includes a processor such as a CPU and a memory such as a PAM. The processing circuit 71 includes an acquisition unit 711, a feature extraction unit 712, a reconstruction unit 713, an error calculation unit 714, a determination unit 715, and a display control unit 716. The processing circuit 71 executes an abnormality detection program concerning abnormality detection using a machine learning model according to this embodiment, thereby implementing the functions off the units 711 to 716.

The abnormality detection program is stored in a non-transitory computer-readable recording medium such as the storage device 72. The abnormality detection program may be implemented as a single program that describes all the functions of the units 711 to 716, or may be implemented as a plurality of modules divided into several functional units. In addition, the units 711 to 716 may be implemented by an integrated circuit such as an ASIC. In this case, the units may be implemented on a single integrated circuit, or may be individually implemented on a plurality of integrated circuits.

The acquisition unit 711 acquires diagnostic data. The diagnostic data is data of an abnormality detection target and means input data to a trained machine learning model.

The feature extraction unit 712 applies the diagnostic data to a feature extraction layer 11 of a machine learning model 1, thereby generating feature data (to be referred to as diagnostic feature data hereinafter) corresponding to the diagnostic data.

The reconstruction unit 713 applies the diagnostic feature data to a reconstruction layer 12 of the machine learning model 1, thereby generating reconstructed data (to be referred to as diagnostic reconstructed data hereinafter) that reproduces the diagnostic data.

The error calculation unit 714 calculates the error between the diagnostic data and the diagnostic feature data. More specifically, the error calculation unit 714 applies the diagnostic data and the diagnostic feature data to an error calculation layer 13 of the machine learning model 1, thereby calculating the error.

The determination unit 715 compares the error between the diagnostic data and the diagnostic feature data with an abnormality determination threshold, thereby determining the presence/absence of abnormality of the diagnostic data, in other words, abnormality or normality. More specifically, the determination unit 715 applies the error to a determination layer 14 of the machine learning model 1, and outputs a determination result of the presence/absence of abnormality.

The display control unit 716 displays various kinds of information on the display device 75. As an example, the display control unit 716 displays the determination result of the presence/absence of abnormality in a predetermined display form.

The storage device 72 is formed by a ROM, an HDD, an SSD, an integrated circuit storage device, or the like. The storage device 72 stores a trained machine learning model generated by the machine learning apparatus 2 according to the first embodiment, an abnormality detection program, and the like.

The input device 73 inputs various kinds of instructions from a user. As the input device 73, a keyboard, a mouse, various kinds of switches, a touch pad, a touch panel display, and the like can be used. An output signal from the input device 73 is supplied to the processing circuit 71. Note that the input device 73 may be an input device of a computer connected to the processing circuit 71 by a cable or wirelessly.

The communication device 74 is an interface configured to perform data communication with an external device connected to the abnormality detection apparatus 7 via a network. For example, the communication device 74 receives training data from a training data generation device, a storage device, or the like. In addition, the communication device 74 receives a trained machine learning model from the machine learning apparatus 2.

The display device 75 displays various kinds of information. As an example, the display device 75 displays a determination result of the presence/absence of abnormality under the control of the display control unit 716, As the display device 75, a CRT display, a liquid crystal display, an organic EL display, an LED display, a plasma display, or another arbitrary display known in the technical field can appropriately be used. Also, the display device 75 may be a projector.

Abnormality detection processing for diagnostic data by the abnormality detection apparatus 7 according to the second embodiment will be described below. The abnormality detection processing is performed using the trained machine learning model 1 generated by the machine learning apparatus 2 according to the first embodiment. The trained machine learning model 1 is stored in the storage device 72 or the like.

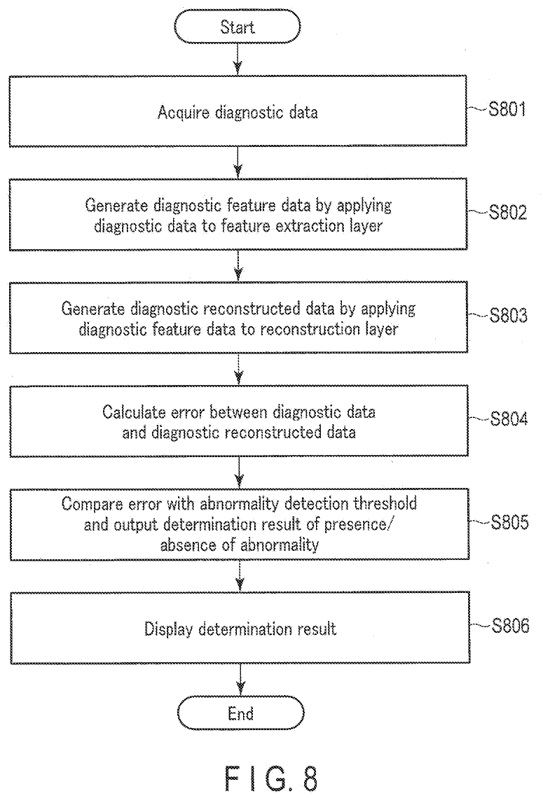

FIG. 8 is a flowchart showing an example of the procedure of abnormality detection processing. The abnormality detection processing shown in FIG. 8 is implemented by the processing circuit 71 reading out an abnormality detection program from the storage device 72 or the like and executing processing in accordance with the description of the abnormality detection program. Also, the processing circuit 71 reads out the trained machine learning model 1 from the storage device 72 or the like.

As shown in FIG. 8, the acquisition unit 711 acquires diagnostic data (step S801). The diagnostic data is data of an abnormality detection target, and whether it is abnormal or normal is unknown.

When step S801 is performed, the feature extraction unit 712 applies the diagnostic data acquired in step S801 to the feature extraction layer 11, thereby generating diagnostic feature data (step S802). A learning parameter optimized in step S302 according to the first embodiment is assigned to the feature extraction layer 11.

When step S802 is performed, the reconstruction unit 713 applies the diagnostic feature data generated in step S802 to the reconstruction layer 12, thereby generating diagnostic reconstructed data (step S803). A learning parameter W optimized in step S304 is assigned to the reconstruction layer 12. The reconstruction layer 12 multiplies diagnostic feature data Φ(x) by the learning parameter W, thereby outputting reconstructed data y=WΦ(x). As described above, the learning parameter W has representative vectors as many as a dimension count H of the diagnostic feature data Φ(x). An operation in the reconstruction layer 12 results in a weighted sum using the component of the diagnostic feature data Φ(x) corresponding to the representative vector as a weight.

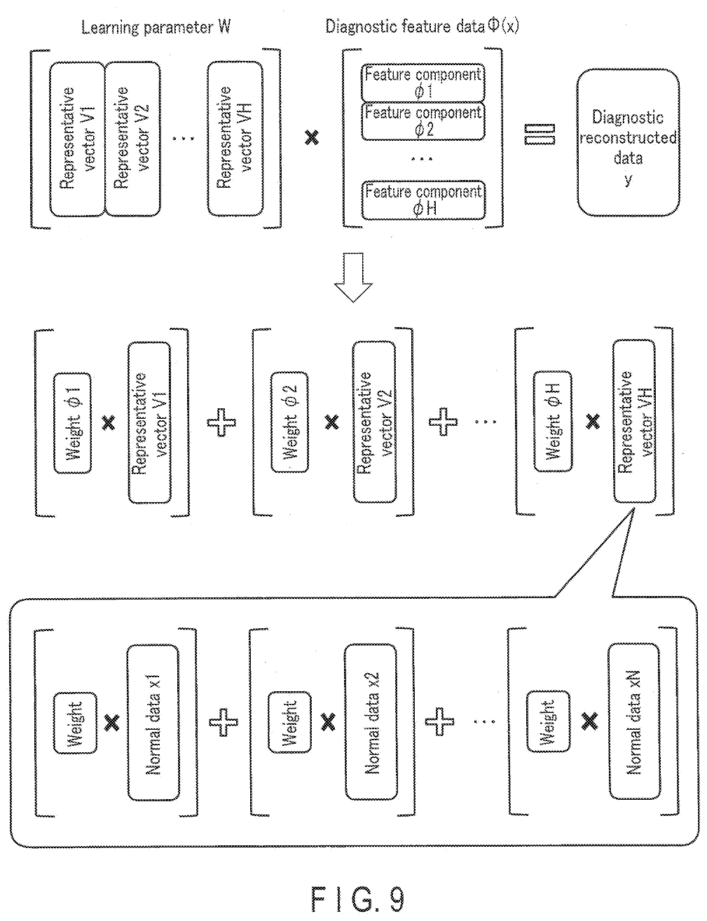

FIG. 9 is a view schematically showing equation expression of an operation in the reconstruction layer 12.

As described above, the learning parameter W has representative vectors Vh as many as the dimension count. H of the diagnostic feature data Φ(x). The diagnostic reconstructed data y is calculated by the weighted sum (linear combination) of the representative vector Vh using a component ϕh of the diagnostic feature data Φ(x) corresponding to the representative vector Vh as a weight (coefficient), The component ϕh functions as a weight for the representative vector Vh. The representative vector Vh corresponds to the weighted sum of N normal data xi used for machine learning of the reconstruction layer 12. The weight here corresponds to a component corresponding to each normal data xi of Φ(X)^{T} [Φ(X)Φ(X)^{T}+λI]⁻¹ shown by equation (3).

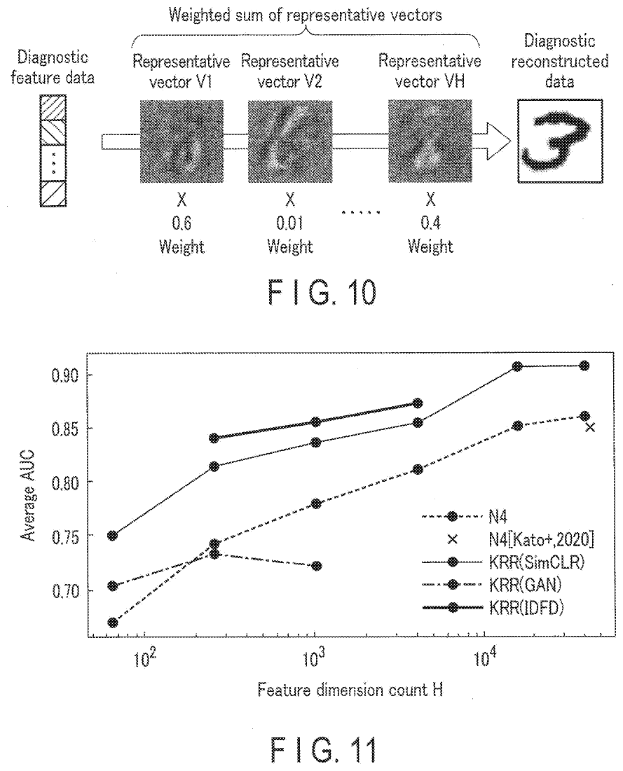

FIG. 10 is a view schematically showing image expression of an operation in the reconstruction layer 12. As shown in FIG. 10, in the reconstruction layer 12, the weighted sum of the representative vector is caused to act on the diagnostic feature data, thereby generating a diagnostic reconstructed data. As shown in FIG. 10, each representative vector is a number image that is the same as the diagnostic data (input data). An object represented by the weighted sum of numbers from “1” to “9” is drawn in each representative vector.

When step S803 is performed, the error calculation unit 714 calculates the error between the diagnostic data acquired in step S801, and the diagnostic reconstructed data generated in step S803 (step S804) More specifically, the error calculation unit 714 applies the diagnostic data and the diagnostic reconstructed data to the error calculation layer 13, thereby calculating the error. As the error, the error calculated in step S606 is used, and, in this embodiment, a square error is preferably used.

When step S804 is performed, the determination unit 715 applies the error calculated in step S304 to the determination Layer 14, and outputs the determination result of the presence/absence of abnormality of the diagnostic data (step S805). An abnormality detection threshold set in step S607 is assigned to the determination layer 14. If the error is larger than the abnormality detection threshold, it is determined that the diagnostic data is abnormal. If the error is smaller than the abnormality detection threshold, it is determined that the diagnostic data is normal.

When step S805 is performed, the display control unit 716 displays the determination result output in step S805 (step S806). For example, whether the diagnostic data is abnormal or normal is preferably displayed as the determination result on the display device 75.

The abnormality detection performance of the machine learning model 1 according to this embodiment will be described here. The abnormality detection performance is a capability of correctly reproducing input data that is normal data and inhibiting correct reproduction of input data that is abnormal data.

FIG. 11 is a graph showing the abnormality detection performance of the machine learning model 1. The ordinate of FIG. 11 represents an average AUC that shows the abnormality detection performance, and the abscissa represents the dimension count H of feature data. Note that as an example, the average AUC is calculated by the average value of the AUC (Area Under Curve) of a ROC curve. The average AUC corresponds to the ratio of a true positive rate that is a rate of not correctly reproducing abnormal data and a true negative rate that is a rate of correctly reproducing normal data. KRR (IDFD) is the machine learning model 1 according to this embodiment, which includes the feature extraction layer 11 and the reconstruction layer 12 for implementing kernel ridge reconstruction, and the learning parameter Θ of the feature extraction layer 11 is trained by contrastive learning according to this embodiment. KRR (GAN) is a kernel ridge reconstruction, and the learning parameter of the feature extraction layer is trained by GAN. KRR (SimCLR) is a kernel ridge reconstruction, and the learning parameter of the feature extraction layer is trained by SimCLR. N4 is a general neural network nearest neighbor method. N4 [Kato+, 2020] is a neural network nearest neighbor method shown in above non-patent literature.

As shown in FIG. 11, the KRR (IDFD) according to this embodiment can exhibit similar abnormality detection performance by a memory amount of about 1.5% of N4. Also, as compared to another method, KRR (IDFD) according to this embodiment can exhibit high abnormality detection performance by a similar memory amount.

The abnormality detection processing is thus ended.

Note that the above-described embodiment is merely an example. The embodiment is not limited to this, and various changes and modifications can be made. For example, in step S806, the display control unit 716 displays the determination result. However, the determination result may be transferred to another computer and displayed,

(Modification 1)

In the above description, training data includes only normal data. However, the embodiment is not limited to this. Training data according to Modification 1 includes normal data and abnormal data.

The first learning unit 212 according to Modification 1 trains the learning parameter Θ by contrastive learning such that the feature extraction layer 11 has the characteristic 2. (When the input data x is abnormal data, if the inner product of the input data is large (or small), the inner product of the feature data is small). That is, if training data includes normal data and abnormal data, the first learning unit 212 trains the learning parameter Θ of the feature extraction layer 11 such that the negative correlation between the inner product of the normal data and the abnormal data and the inner product of feature data corresponding to the normal data and feature data corresponding to the abnormal data becomes high.

When abnormal data is used as training data, it is expected that the performance of identifying normal data and abnormal data by the feature extraction layer 11 improves, and the abnormality detection performance by the machine learning model 1 improves.

(Modification 2)

The first learning unit 212 according to Modification 2 may train the learning parameter Θ by contrastive learning and decorrelation based on the feature data of normal data. By the decorrelation, the correlation between certain normal data and another normal data can be set to almost zero. In this case, a regularization term for decorrelating feature data is preferably added to the contrastive loss function L. As an example a regularization term R for decorrelation is defined by equation (5), The regularization term R is added to the contrastive loss function L of equation (1). However, H in equation (5) is the dimension count of a feature vector z, r{i, j} are the correlation coefficients of ith and jth elements of a vector, and T is a temperature parameter.

$$R = \frac{1}{\vert H \vert} {\sum }_{i = 1}^{H} - log \frac{exp ( {r}_{i , j} / τ )}{{\sum }_{j = 1}^{H} exp ( {r}_{i , j} / τ )} \qquad ( 5 )$$

When decorrelation is performed, it is expected that the performance of identifying normal data and abnormal data by the feature extraction layer 11 improves, and the abnormality detection performance by the machine learning model 1 improves.

(Modification 3)

In the above-described embodiment, the dimension count H is decided in advance. The dimension count H according to Modification 3 may be decided in accordance with a storage capacity needed for the machine learning model 1 and assigned to the storage device 72 of the abnormality detection apparatus 7 that implements the machine learning model 1. As an example, if there is not a sufficient margin for the storage capacity for the machine learning model 1, the dimension count H is preferably set to a relatively small value. As another example, if there is a sufficient margin for the storage capacity for the machine learning model 1, the dimension count H is preferably set to a relatively large value while placing focus on the performance of the machine learning model 1. The storage capacity needed for the machine learning model 1 is preferably designated by the operator. The processing circuit 21 can calculate the dimension count H based on the designated storage capacity and the storage capacity required per dimension.

(Modification 4)

In the above-described embodiment, the machine learning model 1 includes the feature extraction layer 11, the reconstruction layer 12, the error calculation layer 13, and the determination layer 14, as shown in FIG. 1, However, the machine learning model 1 according to this embodiment need only include at least the feature extraction layer 11 and the reconstruction layer 12. That is, calculation of the error between input data and reconstructed data and determination of the presence/absence of abnormality using the abnormality detection threshold need not be incorporated in the machine learning model. In this case, calculation of the error between input data and reconstructed data and determination of the presence/absence of abnormality using the abnormality detection threshold are preferably performed in accordance with a program different from the machine learning model 1 according to Modification 4.

(Additional Remarks)

As described above, the machine learning apparatus 2 according to the first embodiment trains the feature extraction layer 11 that extracts, from input data, feature data of the input data, and the reconstruction layer 12 that generates the reconstructed data of the input data From the feature data. The machine learning apparatus 2 includes the first learning unit 212 and the second learning unit 213. The first learning unit 212 trains the first learning parameter Θ of the feature extraction layer 11 based on N training data. The second learning unit 213 trains the second learning parameter W of the reconstruction layer based on N training feature data obtained by applying the trained feature extraction layer 11 to the N training data. The learning parameter W representing representative vectors as many as the dimension count of the feature data. The representative vectors as many as the dimension count are defined by the weighted sum of the plurality of training data.

As described above, the abnormality detection apparatus 7 according to the second embodiment includes the feature extraction unit 712, the reconstruction unit 713, and the determination unit 715. The feature extraction unit 712 extracts feature data from diagnostic data. The reconstruction unit 713 generates reconstructed data from the feature data. Here, the reconstruction unit 713 generates the reconstructed data based on the weighted sum of the feature data and representative vectors as many as the dimension count of the feature data. The determination unit 715 determines the presence/absence of abnormality of the diagnostic data based on the diagnostic data and the reconstructed data.

According to the above-described configuration, it is possible to save the memory capacity and achieve high abnormality detection performance.

While certain embodiments have been described, these embodiments have been presented by way of example only, and are not intended to limit the scope of the inventions.

Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A machine learning apparatus comprising
a processing circuit configured to
train a first learning parameter of an extraction layer configured to extract, from input data, feature data of the input data, based on a plurality of training data, and
train a second learning parameter of a reconstruction layer configured to generate reconstructed data of the input data, based on a plurality of training feature data obtained by applying the trained extraction layer to the plurality of training data,
wherein the second learning parameter represents representative vectors as many as a dimension count of the feature data, and
the representative vectors as many as the dimension count are defined by a weighted sum of the plurality of training data.

2. The apparatus according to claim 1, wherein
the processing circuit
calculates a false detection rate concerning abnormality detection based on the training feature data obtained by applying the trained extraction layer to the training data and training reconstructed data obtained by applying the trained reconstruction layer to the training feature data, and
displays the false detection rate on a display device.

3. The apparatus according to claim 2, wherein
the processing circuit
calculates a probability distribution of an error between the training feature data and the training reconstructed data,
calculates, as the false detection rate, a probability that the error is not less than a threshold in the probability distribution, and
displays a graph of the false detection rate for the threshold.

4. The apparatus according to claim 3, wherein the processing circuit sets a threshold used to determine presence/absence of abnormality of the input data using a machine learning model including the extraction layer and the reconstruction layer to a value designated via the graph by an operator.

5. The apparatus according to claim 1, wherein if the training data includes only normal data, the processing circuit trains the first learning parameter such that positive correlation between an inner product of two normal data and an inner product of two feature data corresponding to the two normal data becomes high.

6. The apparatus according to claim 1, wherein if the training data includes normal data and abnormal data, the processing circuit trains the first learning parameter such that negative correlation between an inner product of the normal data and the abnormal data and an inner product of feature data corresponding to the normal data and feature data corresponding to the abnormal data becomes high.

7. The apparatus according to claim 1, wherein the processing circuit trains the first learning parameter by contrastive learning and decorrelation based on an inner product of the training data and an inner product of feature data corresponding to the training data.

8. The apparatus according to claim 1, wherein the processing circuit trains the second learning parameter by minimizing an error between the training feature data and training reconstructed data obtained by applying the training feature data to the reconstruction layer.

9. The apparatus according to claim 8, wherein the reconstruction layer is a linear regression model.

10. The apparatus according to claim 1, wherein a machine learning model including the extraction layer and the reconstruction layer includes a determination layer configured to output a determination result of presence/absence of abnormality of the input data based on comparison between a threshold and an error between the reconstructed data and the input data.

11. The apparatus according to claim 1, wherein
the representative vectors as many as the dimension count are defined by the weighted sum of the plurality of training data, and
the weight has a value based on the plurality of training feature data.

12. The apparatus according to claim 1, wherein the dimension count is decided in accordance with a storage capacity that is assigned to a memory of an apparatus in which a machine learning model including the extraction layer and the reconstruction layer is implemented, and is needed for the machine learning model.

13. An abnormality detection apparatus comprising a processing circuit configured to
extract feature data from diagnostic data,
generate reconstructed data from the feature data, the reconstructed data being generated based on a weighted sum of the feature data and representative vectors as many as a dimension count of the feature data, and
determine presence/absence of abnormality of the diagnostic data based on the diagnostic data and the reconstructed data.

14. An abnormality detection method comprising:
extracting feature data from diagnostic data,
generating reconstructed data from the feature data, the reconstructed data being generated based on a weighted sum of the feature data and representative vectors as many as a dimension count of the feature data, and
determining presence/absence of abnormality of the diagnostic data based on the diagnostic data and the reconstructed data.
